(19) United States
(12) Patent Application Publication
(10) Pub. No.: US 2018/0238089 A1
(43) Pub. Date: Aug. 23, 2018

(54) HOOD SUPPORT ROD RETENTION FEATURE

(71) Applicant: GM GLOBAL TECHNOLOGY OPERATIONS LLC, DETROIT, MI (US)

(72) Inventors: Jacob DUVALL, ROYAL OAK, MI (US); James K. SCHOENOW, FRANKENMUTH, MI (US)

(21) Appl. No.: 15/435,893

(22) Filed: Feb. 17, 2017

(51) Int. Cl. E05C 17/12; B62D 25/12; B62D 25/10

(52) U.S. Cl. CPC E05C 17/12; B62D 25/105; B62D 25/12

(57) ABSTRACT

A vehicle assembly includes a closure panel. The closure panel has an interior surface with a receiving aperture disposed thereon. The closure panel is movable between a closed position and an open position. The assembly additionally includes a support member with a proximal end and a distal end. The support member is movable between a stowed position and a deployed position. The assembly further includes a retention element disposed at the distal end. The retention element is configured to deformably engage with the receiving aperture when the closure panel is in the open position and the support member is in the deployed position. The retention element thereby retains the closure panel in the open position.

### TECHNICAL FIELD

The present disclosure relates to motor vehicles. More particularly, the present disclosure relates to such vehicles having closure panels for closing an interior compartment of the vehicle, e.g. an engine compartment.

### INTRODUCTION

An automotive vehicle may be provided with a variety of closure panels for closing interior compartments. Such closure panels may be movable between a closed position, in which the closure panel is generally flush with an exterior surface of the body of the vehicle, and an open position, in which the closure panel is displaced to provide access to the interior compartment. As an example, a hood may be provided for closing an engine compartment of the vehicle. The hood may be hingedly coupled to the vehicle body such that in the closed position the hood protects the engine compartment from environmental factors and debris, while in the open position the hood provides access to the engine compartment for maintenance or other purposes.

### SUMMARY

A vehicle assembly according to the present disclosure includes a closure panel. The closure panel has an interior surface with a receiving aperture disposed thereon. The closure panel is movable between a closed position and an open position. The assembly additionally includes a support member with a proximal end and a distal end. The support member is movable between a stowed position and a deployed position. The assembly further includes a retention element disposed at the distal end. The retention element is configured to deformably engage with the receiving aperture when the closure panel is in the open position and the support member is in the deployed position. The retention element thereby retains the closure panel in the open position.

In an exemplary embodiment, the retention element includes a clip member configured to deformably engage with the receiving aperture.

In such embodiments, the retention element may have a body coupled to the support member, with the clip member having a first end with a tapered profile and a second end coupled to the body. The clip member may have a contoured grip portion between the first end and the second end.

In an exemplary embodiment, the clip member has an inner edge and an outer edge. The inner edge is proximate the body, and the outer edge has a notch thereon for engaging with a closure panel.

In an exemplary embodiment, the retention element comprises a plastic material.

In an exemplary embodiment, the retention element has a body with a hollow bore extending at least partially therethrough, with the support member disposed partially within the bore.

In such embodiments, the support member may include a first engagement feature and the retention element may include a second engagement feature, with the first engagement feature being engaged with the second engagement feature to secure the retention element to the support member. The first engagement feature may include a groove and the second engagement feature may include a projection.

In an exemplary embodiment, the retention element includes a flange extending from the body. In such embodiments, the flange is positioned to inhibit the retention element passing through the receiving aperture.

A prop rod assembly according to the present disclosure includes a support member for supporting a closure panel. The support member has a first end and a second end. The prop rod assembly additionally includes a retention element disposed at the second end. The retention element has a body and a resilient clip member. The body is coupled to the support member. The clip member has a first end and a second end, with the first end having a tapered profile for engagement with an aperture in a closure panel and the second end being coupled to the body.

In an exemplary embodiment, the clip member has a contoured grip portion between the first end and the second end.

In an exemplary embodiment, the retention element comprises a plastic material.

In an exemplary embodiment, the body has a hollow bore extending at least partially therethrough, with the support member being disposed partially within the bore.

In an exemplary embodiment, the support member includes a first engagement feature and the retention element includes a second engagement feature. The first engagement feature is engaged with the second engagement feature to secure the retention element to the support member. In such embodiments, the first engagement feature may include a groove and the second engagement feature may include a projection.

In an exemplary embodiment, the retention element includes a flange extending from the body. The flange is positioned to inhibit the retention element passing through a receiving aperture.

In an exemplary embodiment, the clip member has an inner edge and an outer edge. The inner edge is proximate the body, and the outer edge has a notch thereon for engaging with a closure panel.

A retention element for a prop rod according to the present disclosure includes a body, a flange, and a resilient clip member. The body has a hollow bore extending at least partially therethrough for receiving an elongate support member. The flange extends from the body. The flange is positioned to inhibit the retention element passing through a receiving aperture. The resilient clip member has a first end, a second end, an inner edge, and an outer edge. The first end has a tapered profile for engagement with an aperture in a closure panel. The second end is coupled to the body. The inner edge is proximate the body, and the outer edge has a notch thereon for engaging with a closure panel.

In an exemplary embodiment, the clip member has a contoured grip portion between the first end and the second end.

Embodiments according to the present disclosure provide a number of advantages. For example, a hood assembly according to the present disclosure may securely retain a vehicle hood or other closure panel in an open position until an operator intentionally closes the hood. Moreover, the present disclosure provides a hood assembly which does so in the presence of environmental factors such as wind gusts.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a representation of a vehicle according to the present disclosure;

FIG. 2A is a first view of a retention member according to the present disclosure;

FIG. 2B is a second view of a retention member according to the present disclosure;

FIG. 3A is a first view of a prop rod assembly according to the present disclosure; and

FIG. 3B is a second view of a prop rod assembly according to the present disclosure.

### DETAILED DESCRIPTION

Embodiments of the present disclosure are described herein. It is to be understood, however, that the disclosed embodiments are merely examples and other embodiments considered within the scope of the present disclosure can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the exemplary aspects of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

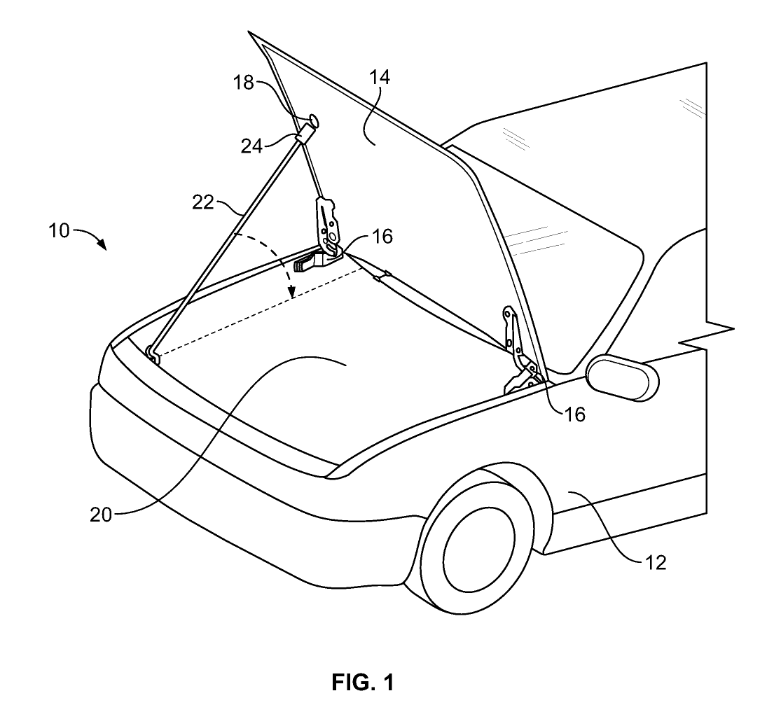

Referring now to FIG. 1, a vehicle 10 according to the present disclosure is illustrated. The vehicle 10 includes a body 12. A closure panel 14, which may be alternatively referred to as a hood, is hingedly coupled to the body 12 via at least one hinge 16. The hood 14 is movable between an open position, as illustrated in FIG. 1, and a closed position in which the hood 14 is generally flush with the exterior of the body 12. The hood 14 is provided with an aperture 18 on an interior surface for receiving a prop rod, as will be discussed further below. In the open position, the hood 14 provides access to an engine compartment 20 for maintenance or other purposes, while in the closed position the hood 14 inhibits debris, rain, or other environmental factors from entering the engine compartment 20.

A pivotable support 22, which may be alternatively referred to as a prop rod, is pivotably coupled to the vehicle 10 and is pivotable relative to the body 12. The prop rod 22 is pivotable between a deployed position and a stowed position, as illustrated by the dashed line. The prop rod 22 is provided with a retention member 24 at a distal end, as will be discussed in further detail below. When the prop rod 22 is in the stowed position, the hood 14 may be closed. When the prop rod 22 is in the deployed position, the retention member 24 may be engaged with the aperture 18 to retain the hood 14 in the open position. While depicted as a rigid member in this embodiment, in other embodiments the prop rod 22 may take other configurations, e.g. telescoping.

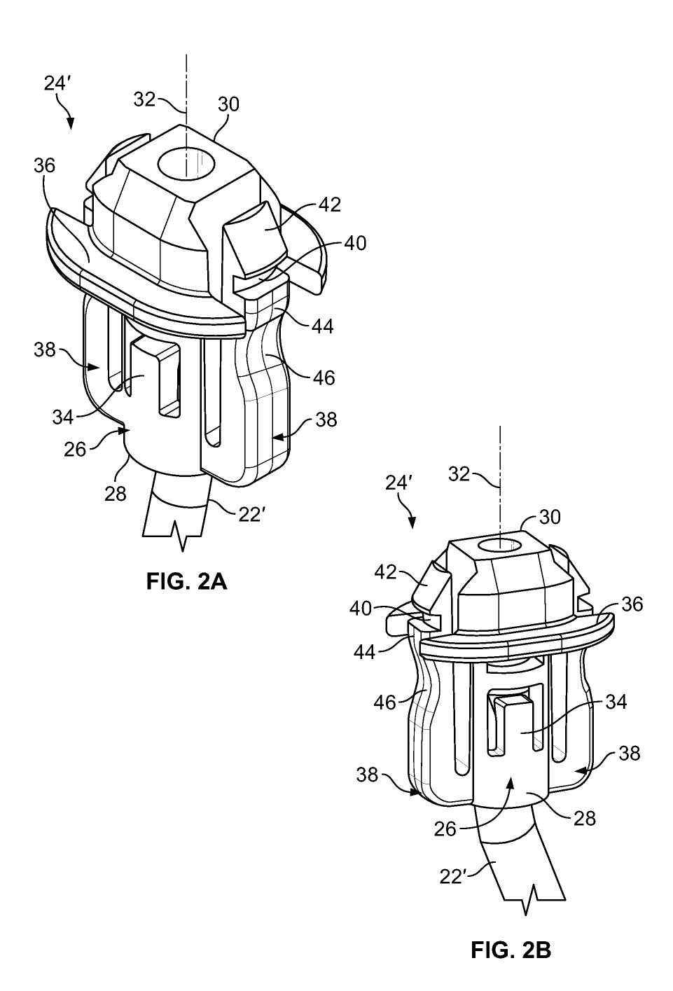

Referring now to FIGS. 2A and 2B, a retention member 24′ according to the present disclosure is illustrated. The retention member 24′ may be implemented in a hood assembly as illustrated in FIG. 1. The retention member 24′ has a generally barrel-shaped body 26 with a proximal end 28 and a distal end 30. The proximal end 28 has a hollow bore formed therein oriented generally along a central axis 32. A prop rod 22′ is disposed within the bore, as illustrated in FIG. 2B. The prop rod 22′ may be a fixed prop rod, telescoping prop rod, or other appropriate device. First and second opposing tab members 34 retain the prop rod 22′ within the bore. In one embodiment, the tab members 34 are resilient members provided with projections extending into the bore, and the prop rod 22′ is provided with grooves in corresponding locations to the projections. In such an embodiment, the retention member 24′ may be assembled to the prop rod 22′ by inserting the 22′ into the bore to engage the projections on the tab members 34 with the grooves on the prop rod 22′. In such an embodiment, the retention member 24′ may thus be secured to the prop rod 22′ in both lateral and rotational orientations. In other embodiments, the retention 24′ may be secured to the prop rod 22′ in other fashions.

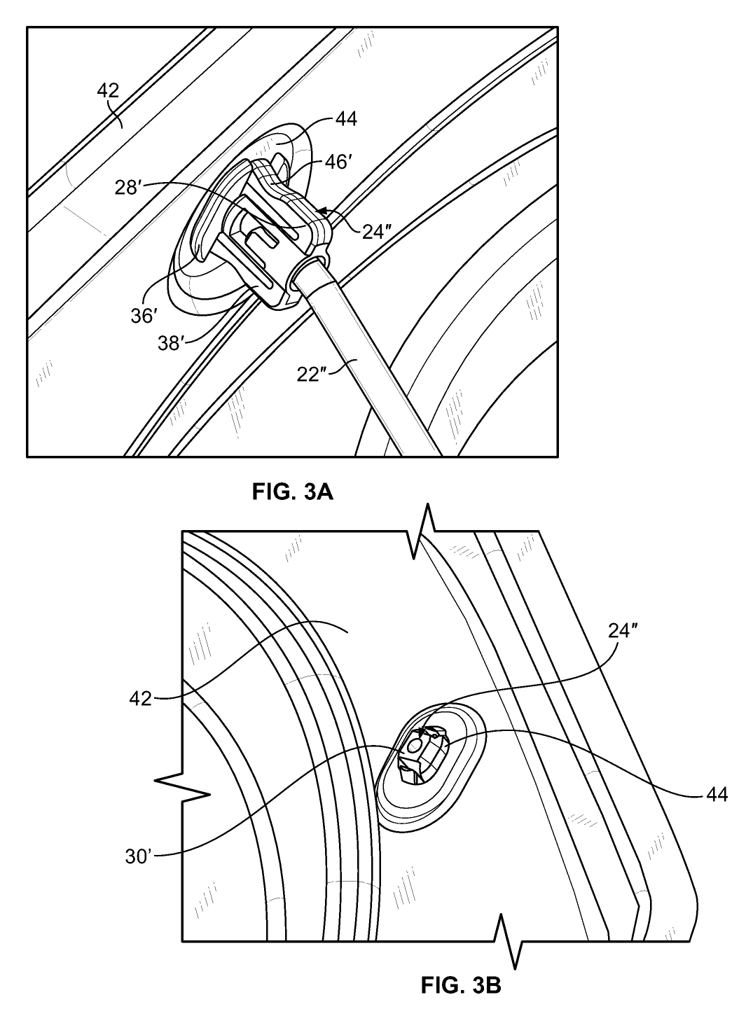

A flange 36 extends circumferentially about at least a portion of the body 26. As will be described in further detail below in conjunction with FIGS. 3A and 3B, the flange 36 provides a stop feature to locate the retention member 24′ in a desired position relative to a vehicle hood. In the embodiment of FIGS. 2A and 2B, the flange 36 is proximate the distal end 30 and has an upper face extending in a plane oriented generally orthogonal to the central axis 32. However, in other embodiments other flange shapes and positions may be used.

At least one resilient clip member 38 is provided on the body 28. As will be described in further detail below in conjunction with FIGS. 3A and 3B, the resilient clip members 38 are configured to deformably engage with a vehicle hood. In the embodiment of FIGS. 2A and 2B, two resilient clip members 38 are provided on opposing sides of the body 26, each coupled to the body 26 proximate the proximal end 28 and extending generally parallel to the central axis 32. However, in other embodiments other clip shapes, numbers of clips, clip positions, or combination thereof may be used.

The resilient clip members 38 include at least one notch 40 for engaging with a hood panel. In the embodiment of FIGS. 2A and 2B, each resilient clip member 38 is provided with a respective notch 40. The notch 40 is disposed on an outer edge of the resilient clip member 38, e.g. opposite an inner edge proximate the body 26, and divides the resilient clip member 38 into a first portion 42 on a first side of the notch and a second portion 44 on a second side of the notch. When engaged with a hood panel, the first portion 42 may protrude through the hood panel. The first portion 42 has a tapered profile in order to facilitate engagement with a hood panel, as will be discussed in further detail below.

A grip portion 46 is provided on the second portion 44 of each notch 40. The grip portions 46 are adapted or contoured to receive a manual force application from a user, e.g. a gripping force applied via an operator's finger. In response to a force applied to the grip portion, the resilient clip member 38 may deflect inward toward the body 26.

In the exemplary embodiment of FIGS. 2A and 2B, the retention member 24′ is formed of a resilient plastic material such as nylon. However, in other embodiments, the retention member 24′ may be formed of other similarly resilient materials. The retention member 24′ may be integrally formed as in the exemplary embodiment of FIGS. 2A and 2B, or may include multiple components coupled together.

Referring now to FIGS. 3A and 3B, a hood assembly is illustrated including a retention member 24″ engaged with a closure panel 42. The retention member 24″ is coupled to a prop rod 22″ and is configured generally the same as the retention member 24′ illustrated in FIGS. 2A and 2B. In the embodiment of FIGS. 3A and 3B, the closure panel 42 is an interior panel of a multi-panel hood assembly. An additional exterior panel, not shown in this view, may be coupled to the panel 42 to define an exterior surface of a vehicle hood.

The closure panel 42 is provided with an aperture 44 extending therethrough. In a preferred embodiment, the aperture 44 does not extend through the exterior panel, thus providing an uninterrupted exterior surface for the vehicle.

To engage the retention member 24″ and the closure panel 42, a distal end 30′ of the retention member 24″ is inserted into the aperture 44. During insertion, resilient clip members 38′ deflect toward a central body 28′ of the retention member 24″ due to tapered edges proximate the distal end 30′. When fully inserted, a flange 36′ abuts the closure panel 42 to locate the retention member 24″ in a desired position relative to the closure panel 42. In addition, when fully inserted, respective notches in the clip members 38′ are aligned with the closure panel 42. The clip members 38′ may then return to their respective original undeflected positions, thereby retaining the closure panel 42 in the respective notches.

As may be seen, the retention member 24″ thus secures the closure panel 42 in position relative to the prop rod 22″ while engaged. This may inhibit unintentional movement of the hood panel during, for example, wind gusts.

To disengage the retention member 24″ from the closure panel 42, an operator may apply pressure to respective grip portions 46′ on the clip members 38′. In response to applied pressure, the clip members 38′ deflect toward the central body 28′, disengaging the closure panel 42 from the respective notches in the clip members 38′. The operator may then withdraw the retention member 24″ from the aperture 44.

As may be seen, the present disclosure provides a hood prop assembly which securely retains a hood panel in an open position until an operator desires to close the hood, even in the presence of environmental factors such as wind gusts. Moreover, the present disclosure provides a hood prop assembly which provides these benefits without requiring additional components coupled to the hood, thus avoiding unnecessary weight or cost increases.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle assembly comprising:
a closure panel having an interior surface with a receiving aperture disposed thereon, the closure panel being movable between a closed position and an open position;
a support member having a proximal end and a distal end, the support member being movable between a stowed position and a deployed position; and
a retention element disposed at the distal end, the retention element being configured to deformably engage with the receiving aperture when the closure panel is in the open position and the support member is in the deployed position to retain the closure panel in the open position.

2. The vehicle assembly of claim 1, wherein the retention element includes a clip member configured to deformably engage with the receiving aperture.

3. The vehicle assembly of claim 2, wherein the retention element has a body coupled to the support member, and wherein the clip member has a first end and a second end, the first end having a tapered profile and the second end being coupled to the body.

4. The vehicle assembly of claim 3, wherein the clip member has a contoured grip portion between the first end and the second end.

5. The vehicle assembly of claim 3, wherein the clip member has an inner edge and an outer edge, the inner edge being proximate the body, the outer edge having a notch thereon for engaging with the closure panel.

6. The vehicle assembly of claim 1, wherein the retention element comprises a plastic material.

7. The vehicle assembly of claim 1, wherein the retention element has a body with a hollow bore extending at least partially therethrough, the support member being disposed partially within the bore.

8. The vehicle assembly of claim 7, wherein the support member includes a first engagement feature and the retention element includes a second engagement feature, the first engagement feature being engaged with the second engagement feature to secure the retention element to the support member.

9. The vehicle assembly of claim 8, wherein the first engagement feature includes a groove and the second engagement feature includes a projection.

10. The vehicle assembly of claim 7, wherein the retention element includes a flange extending from the body, the flange being positioned to inhibit the retention element passing through the receiving aperture.

11. A prop rod assembly comprising:
a support member for supporting a closure panel, the support member having a first end and a second end; and
a retention element disposed at the second end, the retention element having a body and a resilient clip member, the body being coupled to the support member, the clip member having a first end and a second end, the first end having a tapered profile for engagement with an aperture in a closure panel, the second end being coupled to the body.

12. The prop rod assembly of claim 11, wherein the clip member has a contoured grip portion between the first end and the second end.

13. The prop rod assembly of claim 11, wherein the retention element comprises a plastic material.

14. The prop rod assembly of claim 11, wherein the body has a hollow bore extending at least partially therethrough, the support member being disposed partially within the bore.

15. The prop rod assembly of claim 14, wherein the support member includes a first engagement feature and the retention element includes a second engagement feature, the first engagement feature being engaged with the second engagement feature to secure the retention element to the support member.

16. The prop rod assembly of claim 15, wherein the first engagement feature includes a groove and the second engagement feature includes a projection.

17. The prop rod assembly of claim 11, wherein the retention element includes a flange extending from the body, the flange being positioned to inhibit the retention element passing through a receiving aperture.

18. The prop rod assembly of claim 11, wherein the clip member has an inner edge and an outer edge, the inner edge being proximate the body, the outer edge having a notch thereon for engaging with a closure panel.

19. A retention element for a prop rod, the retention element comprising:
a body having a hollow bore extending at least partially therethrough for receiving an elongate support member;
a flange extending from the body, the flange being positioned to inhibit the retention element passing through a receiving aperture; and
a resilient clip member having a first end, a second end, an inner edge, and an outer edge the first end having a tapered profile for engagement with an aperture in a closure panel, the second end being coupled to the body, the inner edge being proximate the body, the outer edge having a notch thereon for engaging with a closure panel.

20. The retention element of claim 19, wherein the clip member has a contoured grip portion between the first end and the second end.
